(19) United States
(12) Patent Application Publication
(10) Pub. No.: US 2024/0291807 A1
(43) Pub. Date: Aug. 29, 2024

(54) SECURE SCALABLE TRANSMISSION OF INAUDIBLE OR ULTRASOUND PACKET URL INSTRUCTIONS FOR SECOND SCREEN APPLICATIONS

(71) Applicant: Audazzio Inc., San Antonio, TX (US)

(72) Inventors: Roger Charlesworth, Kittery Point, ME (US); Shane G. W. Morris, Balitmore, MD (US); Andrew Smith, Santa Barbara, CA (US); Bryan Elliot, San Antonio, TX (US)

(21) Appl. No.: 18/660,195

(22) Filed: May 9, 2024

Related U.S. Application Data
(63) Continuation-in-part of application No. PCT/US22/74121, filed on Jul. 25, 2022.
(60) Provisional application No. 63/277,681, filed on Nov. 10, 2021.

(51) Int. Cl. H04L 9/40

(52) U.S. Cl. CPC H04L 63/0428

(57) ABSTRACT

The present invention generally relates to systems and methods for the efficient and secure creation of unique identifier associated with submitted URLs and the transmission and processing of encrypted signals by a receiving device, and in particular an audio transmission and processing of encrypted unique inaudible signals by a receiving device that may direct the receiving device to initiate an action, such as directing the receiving device to request the associated URL to then access a specific Uniform Resource Locator (URL) or other digital content. The decoding and processing of the transmitted signal is operated on prior to the signal being played through the receiving devices speaker system(s). Consideration to the available signal bit rate is an important aspect of the systems operational integrity.

### CROSS-REFERENCE TO RELATED APPLICATIONS

This International PCT application claims the benefit of and priority to U.S. Provisional Application No. 63/277,681 filed Nov. 10, 2021. The specification, claims, and drawings of which are incorporated herein by reference in their entirety.

### TECHNICAL FIELD

The present invention generally relates to novel systems and methods for securely transmitting and processing encrypted digital content by a receiving device, and in particular the secure transmission of an inaudible or ultrasonic packet instruction to a mobile device responsive to an acoustic audio signal from transmission device that may direct the mobile device to access a website, or other digital content.

### BACKGROUND

As the transmission and display of digital content reaches more and more consumers through the pervasive use of mobile devices and wireless technologies, content providers are seeking additional ways to provide more customized and immersive consumer experiences. One proposal includes the use of second screen experiences wherein content providers can coordinate one or more digital devices to present a multi-screen presentation. However, certain limitations prevent the widespread deployment of such strategies. First, content creators lack a simple and secure method to generate an immersive second-screen experience for remote consumers. Second, content providers, such as broadcast and Over-The-Top (“OTT”) providers, are restricted in their ability to adapt their signal transmission and reception parameters to generate an immersive second-screen experience for remote consumers. For example, cable and OTT streaming services lack excess bandwidth to include additional video and surround audio that can be displayed on a second screen. Notably, the only available frequency range available is in the inaudible, and/or ultrasonic range of the audio portion of a broadcast or streamed signal. Others have suggested using such inaudible signals to passively or actively communicate and provide secondary digital content to a remote device, such as a mobile phone or tablet, however such attempts have been limited. For example, Williams et al., (U.S. patent Ser. No. 11/126,394) describes the use of hidden data embedded in inaudible audio signals, however such system lacks sufficient encryption protocols to securely deliver the hidden data and further lacks sufficient connections to traditional internet architecture to bypass technical bottlenecks inherent in its system. Further, the systems of Williams lack the ability to integrate third-party content generators into the system to allow for a more targeted delivery of digital content.

In another example, Mufti at el., (U.S. patent Ser. No. 10/044,448) describes the transmission of audible and inaudible signals containing data that directs an action on a device according to a user's customized profile. Again, the system of Mufti is limited as it lacks sufficient encryption protocols to securely deliver such custom directed signal encoded data. It further lacks efficient use of existing traditional internet architecture to store and transmit encrypted digital content to a user's mobile device, without having to provide the entirety of the digital content in the audio signal. The system of Mufti further lacks the ability of content producers to direct the digital content to be activated on a second screen. Finally, Shah at el., (U.S. Pat. No. 9,299,386) provides resource identifiers encoded within an inaudible signal which is created by the content provider and transmitted to a user's device, which is then used to retrieve or identify a resource such as a webpage or other resource. However, the system of Shah is limited in its ability to securely embed and transmit both audio signals and digital content instructions to a mobile device.

It should also be noted that the prior art fails to take into account the various bandwidths available to the audio passband, and how the delivery of an inaudible and/or ultrasonic signal can be successfully transmitted to a user's device within the limited parameters of that available bandwidth. For example, the successful transmission of an ultrasonic signal, being generally above the human hearing range of approximately 20 KHz, through the broadcast signal chain is a misnomer, and not technically viable as it would fall outside of the generally available bandwidths of most common transmission systems. The present invention addresses this problem to successfully execute the transmission of inaudible and/or ultrasonic signals through the “standard” National Association of Broadcasters (NAB) protocols along with Dolby AC3 encoding and variants of the OTT video delivery system.

As can be seen, there exists a long-felt need for a system to securely allow for the efficient generation and transmission of specific and secure digital content, such as packet URL instructions embedded in inaudible and/or ultrasonic audio signals to a mobile device, wherein the system further allows for a novel second layer of security by initiating an authenticatable return encrypted URL request in one embodiment thereof. Moreover, as described in more detail below, the prior art lacks a commercially viable system that allows for inaudible and/or ultrasonic signals to be programed to be compatible with the available bandwidth for transmission of a certain application, such as a traditional cable broadcast or OTT streaming and the like.

### SUMMARY OF THE INVENTION

In one aspect, the present invention generally relates to systems and methods for the efficient transmission and processing of encrypted inaudible and/or ultrasonic audio signals. In this preferred aspect, the present invention includes systems and methods configured to allow one or more third-party content providers to generate specific digital content, which may be encrypted, and further associated with a unique identifier that may be embedded in an executable audio file, and preferably an executable audio file configured to generate a signal, which may further be an audible signal, or may include an inaudible, or ultrasonic signal. This inaudible signal embedded with a unique identifier may be transmitted to a mobile device as an audio signal, which may preferably be part of a broadcast or other similar media presentation. The inaudible signal of the invention may be received by a mobile device and trigger one or more actions, which in a preferred aspect include sending a request for digital content associated with the unique identifier. This request can be authenticated, such that the stored digital content may be transmitted to the mobile device, for example through traditional wired or wireless networks, or in a preferred embodiment, a digital content instruction may be transmitted to the mobile device, for example through traditional wired or wireless networks, which may cause the mobile device to access the digital content, for example through a browser, or other audio or media application.

In another aspect, the present invention allows a third-party content generator to create a unique identifier based on submitted digital content to a proprietary secure server. The digital content of the invention may include an internet Uniform Resource Locator (URL), a Uniform Resource Identifier (URI), a Uniform Resource Number (URN), a domain name, or an Internet Protocol (IP) address or a combination of the same. The resultant unique identifier can then be embedded into any audio stream, also referred to herein generally as an audio signal or signal. The unique identifier is then received by a receiving device, generally referred to herein sometimes as a mobile device, typically a phone, tablet or other computer that may include a computer executable program configured to receive and identify the unique identifier transmitted by the audio signal. The receiving device is programmed to contact the secure server with a URL request that includes the received unique identifier, sometimes referred to herein as a packet URL request. The URL request can be authenticated by comparing the unique identifier provided in the URL request with the unique identifier stored on the secure server that is associated with the target URL. If the unique identifiers match, the URL request is authenticated and the URL, which may be encrypted, is provided to the receiving device, where it may further be decrypted. As describe herein, the transmission of a URL, generally in the form of a packet URL instruction to a receiving device may include a URL instruction that causes the receiving device to access that URL and display the contents of the associated website on the receiving device's screen, or other visual interface.

In another aspect, the present invention allows a third-party content generator to create a unique identifier based on a submitted internet URL to a proprietary secure server. The resultant unique identifier can then be transmitted through any digital signal, such as a wired or wireless internet or cellular signal and then received by a receiving device, such as a mobile device that includes a computer executable program configured to receive and identify the unique identifier transmitted by the digital signal. The receiving device is programmed to contact the secure server with a packet URL request. The URL request can be authenticated by comparing the unique identifier provided in the URL request with the unique identifier stored on the secure server that is associated with the target URL. If the unique identifiers match, the URL request is authenticated and the URL, which may be encrypted, is provided to the receiving device, where it may further be decrypted through a digital signal.

In another aspect, the proposed inventive technology is directed to a system to coordinate one or more digital devices through various embedded audio signals, and preferably inaudible audio signals. Broadly, in this aspect, the invention allows a third-party content provider to coordinate and encrypt a specific Uniform Resource Locator (URL) via a unique packet on a secure server which can be embedded in an audio signal, and preferably an inaudible audio signal, and transmitted, for example through a secondary device, such as a television, to a receiving device, such as a personal computer, phone or tablet configured to receive the ultrasonic signal. The receiving device includes a computer executable program configured to request a response from the encoding secure server and then authenticate the request and provide the URL instruction to the receiving device such that it automatically directs the device to the specific URL-associated webpage.

In another aspect, the invention allows a third-party content provider, such as a broadcaster, marketer, streaming provider and the like, to securely encrypt and deliver a target URL to a viewer's mobile device, such as a smartphone or tablet. In this preferred aspect, a third-party content provider submits a target URL to a secure server which generates a unique encrypted code, generally referred to herein as a unique identifier that is based on/correlated with the submitted URL. This unique identifier can form an encrypted packet that may further be integrated into an audio file thereby embedding the unique identifier as an inaudible audio signal. This audio file with the encrypted packet can be programed to fall within the available bandwidth parameters for the expected transmission pathway. Such bandwidth parameters may include “standard” National Association of Broadcasters (NAB) protocols along with Dolby AC3 encoding as well as variants of the OTT video delivery system variants, wherein each protocol has a specific bandwidth parameter for transmission that the audio signal of the invention cannot exceed. The above identified bandwidth parameters and protocols would be known and understood by those of ordinary skill in the art in the audio engineering, and broadcast transmission industries respectively. The third-party content provider can receive the programed audio file, then transmit the inaudible audio signal having an embedded unique identifier through a second device, such as a television, such transmission being at a range that is within the available bandwidth parameters for that television broadcast. The inaudible audio signal is received by the user's device, for example through an audio receiver such as a microphone. The embedded signal initiates an executable program which directs the device to request the URL from the secure server where the request for the specific URL is verified. Once verified, the requested URL instruction is transmitted to the receiving device where it may further be decrypted. The receiving device then connects to that submitted URL-associated website and the resultant content is displayed on the receiving device's screen.

Additional aspects of the invention may be evident from the detailed descriptions, figures and claims provided herein.

### BRIEF DESCRIPTION OF FIGURES

The above and other aspects, features, and advantages of the present disclosure will be better understood from the following detailed descriptions taken in conjunction with the accompanying figures, all of which are given by way of illustration only, and are not limiting the presently disclosed embodiments, in which:

FIG. 1 shows the functional operation of an exemplary encoded process of the invention's secure transmission and processing system (100), which according to the present invention includes the client login screen and connection to the host server for URL submission and packet creation, and return of packet for introduction to transmit medium, in one embodiment thereof. Specifically, in the embodiment shown, a client computer system (104) may include a client login screen, having preferably a dual factor authentication secure login (101) that permits client access to a website or other application having a user settings screen (102) including client parameter setups, presets, macros and file management as well as a URL entry screen (103) allowing a client to generate one or more URL submissions to be transmitted to a client packet server, also referred to as a client server or more preferably a secure server (107) for further processing, preferably through a LAN/IT connection. In this embodiment, the secure server (107) of the invention generates an encrypted packet, which may be communicated back to a client's computer system (104), and may further be configured to store the URL to be transmitted, which may further be stored in an encrypted configuration. The secure server (107) of the invention may be responsive to a settings module (108) which may control the settings and control of secure server (107), and may further be a separate or integral module of the client server (107). The secure transmission and processing system (100) according to the present invention further may include a management server (109) configured to control the parameters and operation of the secure server (107), preferably through management of the settings module (108). The invention may further include a data logging server (110) configured to be responsive to a management server (109) and/or said secure server (107) and further manage storage of login and client usage information in one embodiment thereof. The secure transmission and processing system (100) according to the present invention further may include a digital audio interface (105) responsive to the client's computer system (104) configured to transfer one or more encrypted packets to a digital audio workstation to facilitate integration into an audio signal to be transmitted to a user's receiving device.

FIG. 2 shows a step-wise block diagram operation of the encode process according to the present invention that includes the client login screen and connection to the host server for URL submission and packet creation, return of packet for introduction to transmit medium, in one embodiment thereof.

FIG. 3 shows the functional operation of an exemplary decode process of the invention's secure transmission and processing system (300), which according to the present invention includes the signal input, recognition, validation request, and return of URL steps respectively, as well as the resultant operation of the receiving device to load the URL page, in one embodiment thereof. Included are management data and information logs. Specifically, in the embodiment shown, the present invention includes a computer executable software program, shown here as an Application Programming Interface (API) (301) responsive to a client application (302) operating on a receiving device (313) of the invention, which in this example is a handheld smartphone. In this embodiment, the API (301) of the invention is embedded in the operational system of the client application (302) consistent with the receiving device's operating system. A transmission device (314) may transmit an audio signal (314) that is received by the receiving device (313), for example through a microphone (303). This embedded computer executable program (304) is configured to receive and process a signal containing an embedded unique identifier (304) from the receiver (303) of the device (313). The embedded computer executable program (304) recognizes the embedded encrypted packet (305) having the embedded unique identifier in the transmitted audio signal (314) which initiates (306) a URL request call (308) directed to the secure server (309) of the invention storing the URL and packet information. The packet URL request (308) is authenticated, and the server and user data stored, and the target URL instruction is returned to the receiving device (313) where it is recognized and confirmed by the API (301) and decrypted. The receiving device (313) is then directed (307) to load the webpage associated with that URL.

FIG. 4 shows a step-wise block diagram of the decode process according to the present invention this includes the signal input, recognition, validation request, and return of URL steps respectively, as well as the resultant operation of the receiving device to load the URL webpage, in one embodiment thereof. Included are management data and information logs.

FIG. 5 shows a schematic diagram for transmitting digital content via an audio signal.

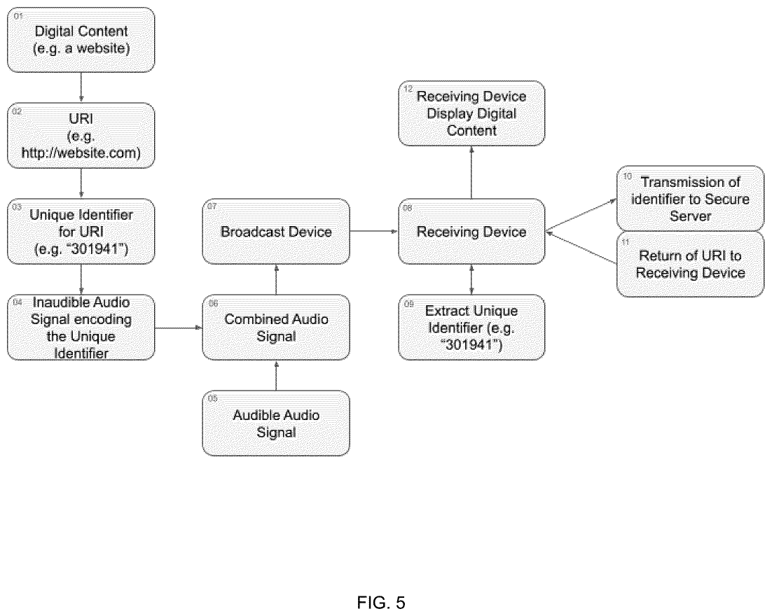

### DETAILED DESCRIPTION OF THE INVENTION

The embodiments herein and the various features and details thereof are explained more fully with reference to the non-limiting embodiments that are illustrated in the accompanying drawings and detailed in the following description. Descriptions of well-known components and processing techniques are omitted to avoid unnecessarily obscuring the embodiments herein. Also, the various embodiments described herein are not necessarily mutually exclusive, as some embodiments can be combined with one or more other embodiments to form new embodiments. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

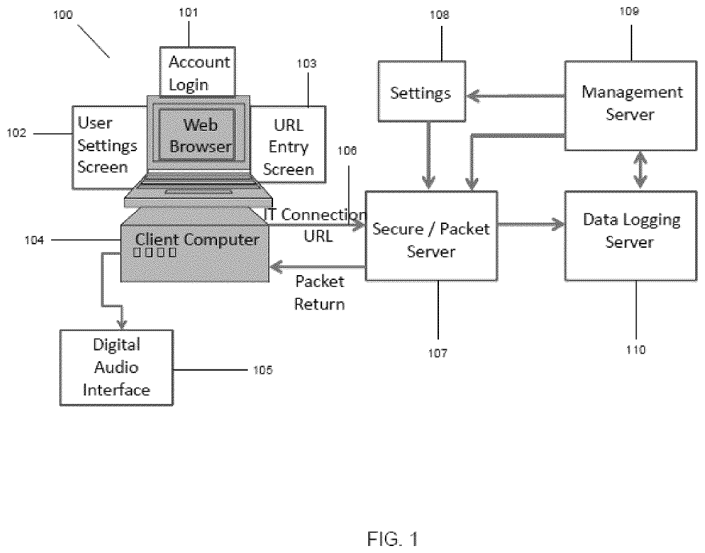

The present invention may include systems and methods to securely transmit and process digital content, and preferably an inaudible and/or ultrasonic unique packet URL instruction, to a mobile device. In this preferred embodiment, a third-party content creator may generate a target URL to be securely transmitted to a mobile device. As shown in FIG. 1, a third-party content creator, generally referred to as a “client” may establish a client computer system, which may include a general purpose computer system or network configured to be responsive to a secure server through a wired or wireless network. To generate a URL to be transmitted, a client may access the client computer system, and further access through a browser application a secure website or application for the entry of a URL to be transmitted. In this embodiment, the client can access the secure website or application through an account login, which may include a dual factor authenticated secure login protocol.

Upon being granted access to the secure website or application, a user may enter a URL to be transmitted through a URL entry screen. Additional parameters of the system can further be adjusted by the client through a user setting screen. Additional parameters may include, but not be limited to coordinating the timing and type of the transmission of one or more URLs to be transmitted to a receiving device, and/or selection of pre-populated URLs and the like. For example, in a preferred embodiment, the step of inputting one or more target URLs may include inputting a plurality of target URL's to be transmitted to a secure server in series, in parallel, at a pre-determined time or event, or in response to an automated or manual signal from the client, user or other third party.

Still further parameters that may be determined by a client can include a parameter whereby the audio signal as describe below is programed to fall within the available bandwidth parameters for the expected transmission pathway. Such bandwidth parameters may include “standard” National Association of Broadcasters (NAB) protocols along with Dolby AC3 encoding as well as variants of the OTT video delivery system variants, wherein each protocol has a specific bandwidth parameter for transmission that the audio signal of the invention cannot exceed. Notably, this parameter can be determined by a client, an operator or may be standardized based on the anticipated transmission pathway.

Notably, as discussed above, the use of ultrasonic signals in one embodiment, and as suggested in the prior art includes certain limitations, namely the available bandwidth for the intended transmission pathway, such as a traditional cable broadcast through a television, or streaming content. In this regarding, in certain embodiments, it may be beneficial, and technically desirable to have the embedded audio signal be audible, or subaudible such that it is compatible with the intended transmission pathway. For example, being at a frequency above or below the available bandwidth results in the embedded signal not being transmissible through the pathway. As such, in certain embodiments, the embedded signal may be transmitted as an audible or subaudible signal to comply with the bandwidth parameter of the transmission pathway, and may further be synchronized with an audible signal in the broadcast such that the audible or subaudible signal is masked by the same.

The target URL may next be transmitted to a secure server where it may further be encrypted and stored for later transmission to a mobile device. Transmission of the target URL may be through a LAN/IT connection, or any other appropriate wired or wireless network connection that would be readily understood by those of ordinary skill in the art. Examples of appropriate wired or wireless networks that may be configured to execute any wired or wireless delivery of the invention may be selected from the group consisting of: an internet network, a wireless network, a Local Area Network (LAN) connection, a Wide Area Network (WAN), Metropolitan Area Network (MAN)

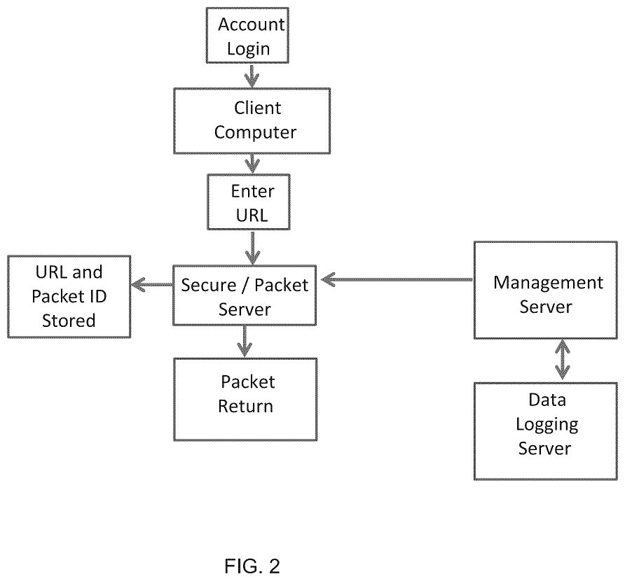

As next shown in FIG. 2, the secure server, sometimes referred to as a “packet server” or “client's packet server” may recognize the transmission of the target URL and generate a unique identifier, such as a random numerical identifier that is associated with the target URL. This unique identifier may be embedded into an executable audio file forming an encrypted packet that can be transmitted back to a client computer system. Notably, while in this example only a single URL is indicated, in alternative embodiments multiple URLs may be input by a client and transmitted to a secure server where they may each be associated with a unique identifier and embedded in an individual executable audio file, while in still other embodiments multiple URLs may be input by a client and transmitted to a secure server where they may be associated with a single unique identifier and embedded in an executable audio file.

As noted above, in certain embodiments the encrypted packet containing the unique identifier embedded in an executable digital audio file comprises an audible or preferably, executable audio file configured to generate an inaudible audio signal. In a preferred embodiment, the encrypted packet containing said unique identifier embedded in an executable audio file is configured to generate an inaudible, subaudible, or ultrasonic audio signal. In still further preferred embodiments, the encrypted packet of the invention may include a Waveform Audio (WAV) or other encoded audio format file embedding the unique identifier as an inaudible, subaudible, or ultrasonic audio signal.

Referring again to FIG. 1, in this embodiment, the encrypted packet, sometimes referred to as a “packet” may be transmitted from the secure server to the client computer system where it may further be integrated into an audio signal, for example an audio signal configured to be broadcast through a transmission device, such as a television or speaker system and the like. Additional transmission devices of the invention may include, but not be limited to a speaker system, an array of speakers, a digital speaker and amplifier, a loudspeaker, a speaker responsive to a digital device, a speaker responsive to a computer, and a speaker responsive to a mobile device. Notably, a mobile device of the invention may include any digital device configured to receive and process an audio signal. Examples of mobile devices of the invention may be selected from the group consisting of: a computer device, a smartphone, a laptop, a computer, a personal digital assistant (PDA), a tablet, a smartwatch, and a mobile communications device.

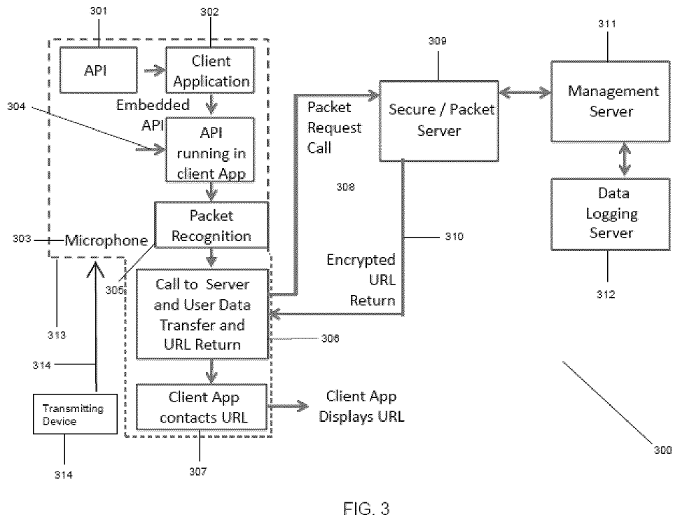

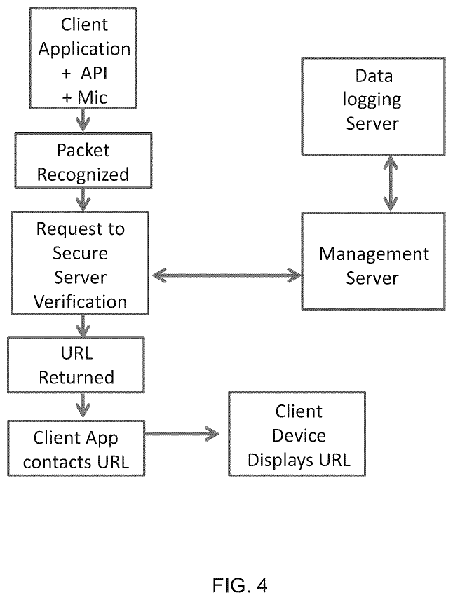

Generally referring now to FIGS. 3-4, a mobile device, having one or more processors responsive to a memory, and configured to receive audible and/or inaudible audio signals, may be actively or passively activated by a user, or in response to reception of an audio signal having an encrypted packet. In a preferred embodiment, the mobile device may include a receiver, such as a microphone or other adaptable device configured to capture and transmit sound to the mobile device.

Again, referring to FIGS. 3-4, upon reception of the audio signal, a computer executable program recognizes the encrypted packet which then initiates a URL request to be sent by the mobile device to the secure server. As noted above, this URL request, also referred to generally as a packet URL request, or packet request, may be transmitted to the secure server through any appropriate wired or wireless connection or network as identified above. The URL request may be authenticated by the secure server. In one embodiment, the URL request from the mobile device may include the unique identifier from the received audio signal, which is compared against the unique identifier stored on the secure server and associated with the target URL. If the unique identifiers match, the URL request is authenticated and the URL, or in a preferred embodiment a URL instruction, is transmitted to the mobile device of the invention. As noted above, the target URL may be encrypted and stored on the secure server. In one embodiment, upon authentication of the URL request the encrypted target URL or in a preferred embodiment a URL instruction, may be decrypted prior to being transmitted to a mobile device. In alternative embodiments, upon authentication of the URL request the encrypted target URL or in a preferred embodiment a URL instruction, may be transmitted to a device where it is recognized and decrypted by the computer executable program of the invention, and preferably the API of the invention operably connected to a client's software application. Notably, the unique identifier of the encrypted packet ensures that only the correct URL is transferred to the mobile device, such that the target URL, unique identifier, encrypted packet, and client application operate in a coordinated fashion so as to eliminate the risk that the wrong URL is provided from the secure server to the client application.

Upon decryption and/or reception of a decrypted target URL instruction by a mobile device, a computer executable program is initiated, and preferably the API of the invention operably connected to a client's software application, to recognize the target URL instruction and directing the mobile device to access said URL-associated website through a browser application and further display the visual and audio content of said URL-associated website on said mobile device. This can be accomplished passively upon reception of the target URL, or through engagement of a permission function on the mobile device, for example through the API of the invention operably connected to a client's software application on the user's device.

As described above, a user may passively or actively engage a receiving device (generally referred to as a “device” or “mobile device”), running a computer executable program, such as an API that is preferably operably responsive to a computer executable program, such as an application or “app”, and preferably an application provided by the same third-party content provider. The API may be operably connected to the device's receiver, such as a microphone or internal data connection that is configured to detect one or more audio signals from, preferably a television, computer, or other sound-enabled device. In this preferred embodiment, the API may be operably responsive to an application provided by the client that generated the URL, such that the step of displaying the URL-associated webpage appears to be seamlessly integrated into the client's application.

One embodiment of the invention includes novel methods and systems to securely submit digital content. In this embodiment, a client, as defined above may identify and generate digital content that it wishes to securely transmit to a mobile device. The client may generate the digital content of the invention through a website that is accessible through a target URL. In this preferred embodiment, a client may submit a URL to be encoded with a unique identifier and stored on a secure server. In one embodiment, this secure server may be a third-party server, or may be a client server that is responsive to a management server configured to generate, or control a secure server in executing the generation of a unique identifier and associating it with the target URL.

As shown in FIG. 1, in one embodiment, the URL may be responsive to a data logging server that stores parameters that the client or operator has established as generally described above. The data logging server may further record and store client login information as well as usage data. This data logging server may be responsive to a management server that may, in certain embodiment generate, or direct the generation by another server, a unique identifier to be associated with the logged URL. The parameters of the management server may be adjusted by a setting module responsive to the management server and/or the secure server. It should be noted that while various server modules have been shown in the Figures and description, in certain embodiment, all such functions may be executed by a single server or like device.

The unique identifier of the invention may be embedded in executable audio file and further transmitted through a transmission device, which may be separate or the same as the receiving device. Regardless of its source, the audio file of the invention may be received by a mobile device having one or more processors responsive to a memory configured to activate a computer executable program, such as an API, upon receiving the audio signal having the embedded unique identifier. Again, referring to FIG. 1-2, a unique identifier embedded in the executable audio file may be for an encrypted packet that may be transmitted to a client computer to be integrated into an audible audio signal that may be part of a planned audio, video, or streaming broadcast. The unique identifier embedded in executable audio file may generate an inaudible, subaudible and/or ultrasonic audio signal. In a preferred embodiment, the unique identifier embedded in executable audio file may include a Waveform Audio (WAV), or other encoded audio format, file embedding the unique identifier that when executed produces the audio signal of the invention. In one embodiment, the unique identifier embedded in executable audio file may be directly embedded into a broadcast flow at a transmission studio, or anywhere along the chain of transmission for the broadcast signal.

The audio signal embedding a unique identifier may be received by a mobile device, for example through a receiver, such as a microphone operably responsive to a computer executable program such that upon reception of the audio signal embedding a unique identifier, the computer executable program is activated and transmits a URL request to a secure server. The URL request is authenticated, for example by comparing the unique identifier of the URL request with the unique identifier associate with the URL stored on a secure server. Upon authentication, the URL or in a preferred embodiment a URL instruction, is sent to the mobile device, for example through an appropriate wired or wireless network and further directing the mobile device to access the URL and display the visual and audio content of said URL-associated website, preferably though a browser application of the device.

The present invention further describes systems and methods for transmitting digital content via an audio signal. In one embodiment, the method includes the step of establishing digital content, such as a website, audio of visual digital content, or other executable program, that can be acted upon by a receiving device as generally described. In this preferred embodiment, the digital content is associated with a Uniform Resource Identifier (URI) that is configured to be displayed or acted upon by a receiving device. Next, the URI is associated with a unique identifier code, which can include an alphanumerical or numerical codes that is unique that that digital content for later identification and authentication.

In a preferred embodiment, the unique identifier code is converted into a sound, and preferably an inaudible sound that can be part of an inaudible audio signal. For example, in this preferred embodiment an inaudible audio signal is created encoding the unique identifier code as a sound, and preferably an inaudible sound that can be embedded in an audio signal, and preferably an audible audio signal forming a combined signal. This combined signal can be broadcast as generally described herein where it can be picked up by a receiving device that identifies the inaudible audio signal and extracts the unique identifier code, which can include recognizing and/or isolating the inaudible audio signal from the combined signal and converting the inaudible sound into the unique identifier code, which can include an alphanumerical or numerical code that has been associated with a digital content. Again, in some embodiments the URI includes a Uniform Resource Locator (URL), a Uniform Resource Number (URN), a domain name, an Internet Protocol (IP) address, a computer executable program, or a combination of the same

The invention now being generally described will be more readily understood by reference to the following examples, which are included merely for the purposes of illustration of certain aspects of the embodiments of the present invention. The examples are not intended to limit the invention, as one of skill in the art would recognize from the above teachings and the following examples that other techniques and methods can satisfy the claims and can be employed without departing from the scope of the claimed invention.

### Example 1: Live Entertainment Venues

In one embodiment of the present invention, a client may desire to provide, and a user may desire to receive coordinated real-time content relevant to a live entertainment event on a secondary screen, such as a mobile device. Such real-time content may include relevant information related to the live event or venue, promotions or other pushed-content features, instructions or information regarding the current or past events at that venue, and the like. In this example, a user may activate a computer executable software application on their mobile device that is embedded with the API of invention configured to facilitate the secure transfer of packet URLs instructions to a user's mobile device. A client may generate one or more URLs to be transmitted through an audio signal broadcast at the event, such as through a public announcement system, or through pre-recorded or live audio presentations. As described above, the inventive system may receive an audio signal embedding a unique identifier associated with a target URL uploaded by a client to a secure server. This audio signal may be audible, subaudible, inaudible and/or ultrasonic, and may further be in the form of acoustic waves, or an electromagnetic signal, and may further be programed to fall within the bandwidth parameters of the anticipated transmission pathway. The inventive system described herein may transmit a unique identifier associated with the target URL embedded within the signal, and causing the mobile device to submit a URL request to a secure server. The central secure server may then authenticate that URL request and send the target URL back to the user's receiving device, which may preferably include a packet URL instruction, which causes the user's device to access the target URL and display the associated website in a browser of the device.

### Example 2: Sports Venues and E-Sports Broadcasts

In one embodiment of the present invention, a client may desire to provide, and a user may desire to receive coordinated real-time content relevant to a live sporting event on a secondary screen, such as a mobile device. Such real-time content may include relevant information related to the sporting event, or venue, promotions, player statistics, event replays or secondary commentary and the like. In one embodiment, the invention may direct a user to a URL-associated website that allows the user to access and participate in virtual gambling or betting services provided by the venue, or a third party. In this example, a user may activate a computer executable software application on their mobile device that is embedded with the API of invention configured to facilitate the secure transfer of packet URLs instructions to a user's mobile device. A client may generate one or more URLs to be transmitted through an audio signal broadcast at a live event, such as through a public announcement system, or through pre-recorded or live audio presentations. In an alternative embodiment, the client may generate one or more URLs to be transmitted through an audio signal broadcast or transmitted through a transmission device, such as a television or other computer-enabled speaker and the like. As described above, the inventive system may receive an audio signal embedding a unique identifier associated with a target URL uploaded by a client to a secure server. This audio signal may be audible, subaudible, inaudible and/or ultrasonic, and may further be in the form of acoustic waves, or an electromagnetic signal, and may further be programed to fall within the bandwidth parameters of the anticipated transmission pathway. The inventive system described herein may transmit a unique identifier associated with the target URL embedded within the signal, and causing the mobile device to submit a URL request to a secure server. The central secure server may then authenticate that URL request and send the target URL back to the user's receiving device, which may preferably include a packet URL instruction, which causes the user's device to access the target URL and display the associated website in a browser of the device.

### Example 3: Restaurants and Taverns

In one embodiment of the present invention, a client may desire to provide, and a user may desire to receive coordinated real-time content relevant to a restaurant or tavern on a secondary screen, such as a mobile device. Such real-time content may include relevant information related to the restaurant or venue and its product offerings, such as a menu or wait times, as well as advertisements, or promotions, such as promotional codes, discounts, coupons, voucher, or contests and the like. In another example, a user may be directed to a URL that allows the user to place or modify their order ahead of time. In this example, a user may activate a computer executable software application on their mobile device that is embedded with the API of invention configured to facilitate the secure transfer of packet URLs instructions to a user's mobile device. A client may generate one or more URLs to be transmitted through an audio signal broadcast at the restaurant, such as through a public announcement system, or through pre-recorded or live audio presentations. In an alternative embodiment, the client may generate one or more URLs to be transmitted through an audio signal broadcast or transmitted through a transmission device, such as a television or other computer-enabled speaker that is present in the restaurant or other similar location or business. As described above, the inventive system may receive an audio signal embedding a unique identifier associated with a target URL uploaded by a client to a secure server. This audio signal may be audible, subaudible, inaudible and/or ultrasonic, and may further be in the form of acoustic waves, or an electromagnetic signal, and may further be programed to fall within the bandwidth parameters of the anticipated transmission pathway. The inventive system described herein may transmit a unique identifier associated with the target URL embedded within the signal, and causing the mobile device to submit a URL request to a secure server. The central secure server may then authenticate that URL request and send the target URL back to the user's receiving device, which may preferably include a packet URL instruction, which causes the user's device to access the target URL and display the associated website in a browser of the device.

### Example 4: Shopping Malls and Retail Venues

In one embodiment of the present invention, a client may desire to provide, and a user may desire to receive coordinated real-time content relevant to a retail or other businesses on a secondary screen, such as a mobile device. Such real-time content may include relevant information related to the business or retail venue, such as a mall, and its product offerings, direction, customer information, as well as advertisements, or promotions, such as promotional codes, discounts, coupons, or contests and the like. In another example, a user may be directed to a URL that allows the user to purchase a product from a retail establishment for later pick-up. In this example, a user may activate a computer executable software application on their mobile device that is embedded with the API of invention configured to facilitate the secure transfer of packet URLs instructions to a user's mobile device. A client may generate one or more URLs to be transmitted through an audio signal broadcast at the retail location, such as through a public announcement system, or through pre-recorded or live audio presentations. In an alternative embodiment, the client may generate one or more URLs to be transmitted through an audio signal broadcast or transmitted through a transmission device, such as a television or other computer-enabled speaker that is present in the business location or other similar location or business. As described above, the inventive system may receive an audio signal embedding a unique identifier associated with a target URL uploaded by a client to a secure server. This audio signal may be audible, subaudible, inaudible and/or ultrasonic, and may further be in the form of acoustic waves, or an electromagnetic signal, and may further be programed to fall within the bandwidth parameters of the anticipated transmission pathway. The inventive system described herein may transmit a unique identifier associated with the target URL embedded within the signal, and causing the mobile device to submit a URL request to a secure server. The central secure server may then authenticate that URL request and send the target URL back to the user's receiving device, which may preferably include a packet URL instruction, which causes the user's device to access the target URL and display the associated website in a browser of the device.

### Example 5: Educational Institutions

In one embodiment of the present invention, a client may desire to provide, and a user may desire to receive coordinated real-time content relevant to an educational institution on a secondary screen, such as a mobile device. Such real-time content may include relevant information related to the educational instruction and its services, public service or other institution-wide announcements, as well as primary or supplemental teaching materials or presentations that can be used as primary or supplementary educational resources. In this example, a user may activate a computer executable software application on their mobile device that is embedded with the API of invention configured to facilitate the secure transfer of packet URLs instructions to a user's mobile device. A client may generate one or more URLs to be transmitted through an audio signal broadcast at the retail location, such as through a public announcement system, or through pre-recorded or live audio presentations. In an alternative embodiment, the client may generate one or more URLs to be transmitted through an audio signal broadcast or transmitted through a transmission device, such as a television or other computer-enabled speaker that is present at one or more locations of the educational institution or other similar location or business. As described above, the inventive system may receive an audio signal embedding a unique identifier associated with a target URL uploaded by a client to a secure server. This audio signal may be audible, subaudible, inaudible and/or ultrasonic, and may further be in the form of acoustic waves, or an electromagnetic signal, and may further be programed to fall within the bandwidth parameters of the anticipated transmission pathway. The inventive system described herein may transmit a unique identifier associated with the target URL embedded within the signal, and causing the mobile device to submit a URL request to a secure server. The central secure server may then authenticate that URL request and send the target URL back to the user's receiving device, which may preferably include a packet URL instruction, which causes the user's device to access the target URL and display the associated website in a browser of the device.

### Example 6: Casinos and Gaming Venues

In one embodiment of the present invention, a client may desire to provide, and a user may desire to receive coordinated real-time content relevant to a casino and gaming businesses on a secondary screen, such as a mobile device. Such real-time content may include relevant information related to the casino and gaming venue and its services, customer accommodations, marketing materials such as giveaways and promotional discounts or code. In one embodiment, the invention may direct a user to a URL-associated website that allow the user to access and participate in virtual gambling or betting services provided by the venue. In this example, a user may activate a computer executable software application on their mobile device that is embedded with the API of invention configured to facilitate the secure transfer of packet URLs instructions to a user's mobile device. A client may generate one or more URLs to be transmitted through an audio signal broadcast at the retail location, such as through a public announcement system, or through pre-recorded or live audio presentations. In an alternative embodiment, the client may generate one or more URLs to be transmitted through an audio signal broadcast or transmitted through a transmission device, such as a television or other computer-enabled speaker that is present at one or more locations of the casino and gaming venue or other similar location or business. As described above, the inventive system may receive an audio signal embedding a unique identifier associated with a target URL uploaded by a client to a secure server. This audio signal may be audible, subaudible, inaudible and/or ultrasonic, and may further be in the form of acoustic waves, or an electromagnetic signal, and may further be programed to fall within the bandwidth parameters of the anticipated transmission pathway. The inventive system described herein may transmit a unique identifier associated with the target URL embedded within the signal, and causing the mobile device to submit a URL request to a secure server. The central secure server may then authenticate that URL request and send the target URL back to the user's receiving device, which may preferably include a packet URL instruction, which causes the user's device to access the target URL and display the associated website in a browser of the device.

### Example 7: Houses of Worship

In one embodiment of the present invention, a client may desire to provide, and a user may desire to receive coordinated real-time content relevant to an houses of worship on a secondary screen, such as a mobile device. Such real-time content may include relevant information related to the house of worship, it activities or event, planned services, as well as distribution of religious materials and the like. In this example, a user may activate a computer executable software application on their mobile device that is embedded with the API of invention configured to facilitate the secure transfer of packet URLs instructions to a user's mobile device. A client may generate one or more URLs to be transmitted through an audio signal broadcast at the retail location, such as through a public announcement system, or through pre-recorded or live audio presentations. In an alternative embodiment, the client may generate one or more URLs to be transmitted through an audio signal broadcast or transmitted through a transmission device, such as a television or other computer-enabled speaker that is present at one or more houses of worship. As described above, the inventive system may receive an audio signal embedding a unique identifier associated with a target URL uploaded by a client to a secure server. This audio signal may be audible, subaudible, inaudible and/or ultrasonic, and may further be in the form of acoustic waves, or an electromagnetic signal, and may further be programed to fall within the bandwidth parameters of the anticipated transmission pathway. The inventive system described herein may transmit a unique identifier associated with the target URL embedded within the signal, and causing the mobile device to submit a URL request to a secure server. The central secure server may then authenticate that URL request and send the target URL back to the user's receiving device, which may preferably include a packet URL instruction, which causes the user's device to access the target URL and display the associated website in a browser of the device.

### Example 8: Transportation Infrastructure and Operations

In one embodiment of the present invention, a client may desire to provide, and a user may desire to receive coordinated real-time content relevant to transportation and infrastructure operations on a secondary screen, such as a mobile device. Such real-time content may include relevant information related to the information related to airport, subway and train locations and their specific services, instructions and details regarding, for example arrival or departure times, emergency broadcasts as well as alerts regarding delays, or other passenger related information such as national and international travel guidelines or restrictions. Additional embodiments may include ticketing and check-in services as well as secondary accommodations, such as hotel and car rental, as well as information regarding one or more destination. In this example, a user may activate a computer executable software application on their mobile device that is embedded with the API of invention configured to facilitate the secure transfer of packet URLs instructions to a user's mobile device. A client may generate one or more URLs to be transmitted through an audio signal broadcast at the retail location, such as through a public announcement system, or through pre-recorded or live audio presentations. In an alternative embodiment, the client may generate one or more URLs to be transmitted through an audio signal broadcast or transmitted through a transmission device, such as a television or other computer-enabled speaker that is present at one or more locations associated with travel or infrastructure. As described above, the inventive system may receive an audio signal embedding a unique identifier associated with a target URL uploaded by a client to a secure server. This audio signal may be audible, subaudible, inaudible and/or ultrasonic, and may further be in the form of acoustic waves, or an electromagnetic signal, and may further be programed to fall within the bandwidth parameters of the anticipated transmission pathway. The inventive system described herein may transmit a unique identifier associated with the target URL embedded within the signal, and causing the mobile device to submit a URL request to a secure server. The central secure server may then authenticate that URL request and send the target URL back to the user's receiving device, which may preferably include a packet URL instruction, which causes the user's device to access the target URL and display the associated website in a browser of the device.

### Example 13: Emergency Warning System

In one embodiment of the present invention, a client may desire to provide, and a user may desire to receive coordinated real-time content relevant to emergency warning systems on a secondary screen, such as a mobile device. Such real-time content may include relevant information related to the transmitting and distributing emergency warning, such as AMBER Alerts, or sever weather warnings, as well as safety or resource information for persons that may be presented with an actual or imminent emergency situation. In this example, a user may activate a computer executable software application on their mobile device that is embedded with the API of invention configured to facilitate the secure transfer of packet URLs instructions to a user's mobile device. A client may generate one or more URLs to be transmitted through an audio signal broadcast at the retail location, such as through a public announcement system, or through pre-recorded or live audio presentations. In an alternative embodiment, the client may generate one or more URLs to be transmitted through an audio signal broadcast or transmitted through a transmission device, such as a television or other computer-enabled speaker that is present in a user's home or workplace or other similar location. As described above, the inventive system may receive an audio signal embedding a unique identifier associated with a target URL uploaded by a client to a secure server. This audio signal may be audible, subaudible, inaudible and/or ultrasonic, and may further be in the form of acoustic waves, or an electromagnetic signal, and may further be programed to fall within the bandwidth parameters of the anticipated transmission pathway. The inventive system described herein may transmit a unique identifier associated with the target URL embedded within the signal, and causing the mobile device to submit a URL request to a secure server. The central secure server may then authenticate that URL request and send the target URL back to the user's receiving device, which may preferably include a packet URL instruction, which causes the user's device to access the target URL and display the associated website in a browser of the device.

### Example 10: Public Opinion Polling

In one embodiment of the present invention, a client may desire to provide, and a user may desire to receive coordinated real-time content relevant to public opinion polling on a secondary screen, such as a mobile device. Such real-time content may include relevant information related to direct polling, exit polling, voter surveys and identification, as well as information regarding candidates and voting services. In this example, a user may activate a computer executable software application on their mobile device that is embedded with the API of invention configured to facilitate the secure transfer of packet URLs instructions to a user's mobile device. A client may generate one or more URLs to be transmitted through an audio signal broadcast at the retail location, such as through a public announcement system, or through pre-recorded or live audio presentations. In an alternative embodiment, the client may generate one or more URLs to be transmitted through an audio signal broadcast or transmitted through a transmission device, such as a television or other computer-enabled speaker that is present at one or more locations of the that may be accessible to a potential voter, such as over the radio or through television commercials and live campaign events and the like. As described above, the inventive system may receive an audio signal embedding a unique identifier associated with a target URL uploaded by a client to a secure server. This audio signal may be audible, subaudible, inaudible and/or ultrasonic, and may further be in the form of acoustic waves, or an electromagnetic signal, and may further be programed to fall within the bandwidth parameters of the anticipated transmission pathway. The inventive system described herein may transmit a unique identifier associated with the target URL embedded within the signal, and causing the mobile device to submit a URL request to a secure server. The central secure server may then authenticate that URL request and send the target URL back to the user's receiving device, which may preferably include a packet URL instruction, which causes the user's device to access the target URL and display the associated website in a browser of the device.

### Example 11: Conference and Exhibition Centers

In one embodiment of the present invention, a client may desire to provide, and a user may desire to receive coordinated real-time content relevant to conference and exhibition centers on a secondary screen, such as a mobile device. Such real-time content may include relevant information related to the conference schedule, as well as primary or secondary content to be presented to a conference attendee, presentation or presenter biographical information, as well as secondary sources of information relevant to a presentation, guided or self-guided automated tours providing information regarding various exhibits and the like, as well as information regarding the venue and it services and accommodations. In this example, a user may activate a computer executable software application on their mobile device that is embedded with the API of invention configured to facilitate the secure transfer of packet URLs instructions to a user's mobile device. A client may generate one or more URLs to be transmitted through an audio signal broadcast at the retail location, such as through a public announcement system, or through pre-recorded or live audio presentations. In an alternative embodiment, the client may generate one or more URLs to be transmitted through an audio signal broadcast or transmitted through a transmission device, such as a television or other computer-enabled speaker that is present at one or more locations of the conference and exhibition centers. As described above, the inventive system may receive an audio signal embedding a unique identifier associated with a target URL uploaded by a client to a secure server. This audio signal may be audible, subaudible, inaudible and/or ultrasonic, and may further be in the form of acoustic waves, or an electromagnetic signal, and may further be programed to fall within the bandwidth parameters of the anticipated transmission pathway. The inventive system described herein may transmit a unique identifier associated with the target URL embedded within the signal, and causing the mobile device to submit a URL request to a secure server. The central secure server may then authenticate that URL request and send the target URL back to the user's receiving device, which may preferably include a packet URL instruction, which causes the user's device to access the target URL and display the associated website in a browser of the device.

### Example 12: Corporate Presentations

In one embodiment of the present invention, a client may desire to provide, and a user may desire to receive coordinated real-time content relevant to a corporate presentation on a secondary screen, such as a mobile device. Such real-time content may include relevant information related to the presenter, the company or entity that is presenting, primary or secondary source or materials that may accompany a presentation, as well as one or more presentations or events that can be displayed on a mobile device. In this example, a user may activate a computer executable software application on their mobile device that is embedded with the API of invention configured to facilitate the secure transfer of packet URLs instructions to a user's mobile device. A client may generate one or more URLs to be transmitted through an audio signal broadcast at the retail location, such as through a public announcement system, or through pre-recorded or live audio presentations. In an alternative embodiment, the client may generate one or more URLs to be transmitted through an audio signal broadcast or transmitted through a transmission device, such as a television or other computer-enabled speaker that is present at one or more locations of the corporate presentation or event. As described above, the inventive system may receive an audio signal embedding a unique identifier associated with a target URL uploaded by a client to a secure server. This audio signal may be audible, subaudible, inaudible and/or ultrasonic, and may further be in the form of acoustic waves, or an electromagnetic signal, and may further be programed to fall within the bandwidth parameters of the anticipated transmission pathway. The inventive system described herein may transmit a unique identifier associated with the target URL embedded within the signal, and causing the mobile device to submit a URL request to a secure server. The central secure server may then authenticate that URL request and send the target URL back to the user's receiving device, which may preferably include a packet URL instruction, which causes the user's device to access the target URL and display the associated website in a browser of the device.

### Example 13: Government Implementations

In one embodiment of the present invention, a client may desire to provide, and a user may desire to receive coordinated real-time content relevant to various government application on a secondary screen, such as a mobile device. Such real-time content may include relevant information related to the encrypted distribution of information and the like. In this example, a user may activate a computer executable software application on their mobile device that is embedded with the API of invention configured to facilitate the secure transfer of packet URLs instructions to a user's mobile device. A client may generate one or more URLs to be transmitted through an audio signal broadcast at the retail location, such as through a public announcement system, or through pre-recorded or live audio presentations. In an alternative embodiment, the client may generate one or more URLs to be transmitted through an audio signal broadcast or transmitted through a transmission device, such as a television or other computer-enabled speaker that is present at one or more personal or governmental locations. As described above, the inventive system may receive an audio signal embedding a unique identifier associated with a target URL uploaded by a client to a secure server. This audio signal may be audible, subaudible, inaudible and/or ultrasonic, and may further be in the form of acoustic waves, or an electromagnetic signal, and may further be programed to fall within the bandwidth parameters of the anticipated transmission pathway. The inventive system described herein may transmit a unique identifier associated with the target URL embedded within the signal, and causing the mobile device to submit a URL request to a secure server. The central secure server may then authenticate that URL request and send the target URL back to the user's receiving device, which may preferably include a packet URL instruction, which causes the user's device to access the target URL and display the associated website in a browser of the device.

### Example 14: Broadcast Implementations

In one embodiment of the present invention, the delivery of the audible, subaudible, inaudible and/or ultrasonic signal depends on the frequency range available to the broadcast infrastructure. This may vary from broadcast company to broadcast company or delivery system (Cox, Fios, Xfinity etc.) to delivery system. The current invention takes into consideration aspects of the available bandwidth to successfully present the receiving device with the packet information and thus allow the receiving device to connect the verification server that allows the client to provide the second screen experience and a user may desire to receive coordinated real-time content relevant to the program.

Such real-time content may include relevant information related to the encrypted distribution of information and the like. In this example, a user may activate a computer executable software application on their mobile device that is embedded with the API of invention configured to facilitate the secure transfer of packet URLs instructions to a user's mobile device. A client may generate one or more URLs to be transmitted through an audio signal broadcast at the retail location, such as through a public announcement system, or through pre-recorded or live audio presentations. In an alternative embodiment, the client may generate one or more URLs to be transmitted through an audio signal broadcast or transmitted through a transmission device, such as a television or other computer-enabled speaker that is present at one or more personal or governmental locations. As described above, the inventive system may receive an audio signal embedding a unique identifier associated with a target URL uploaded by a client to a secure server. This audio signal may be audible or subaudible or inaudible, and may further be in the form of acoustic waves, or an electromagnetic signal, and may further be programed to fall within the bandwidth parameters of the anticipated transmission pathway. The inventive system described herein may transmit a unique identifier associated with the target URL embedded within the signal, and causing the mobile device to submit a URL request to a secure server. The central secure server may then authenticate that URL request and send the target URL back to the user's receiving device, which may preferably include a packet URL instruction, which causes the user's device to access the target URL and display the associated website in a browser of the device.

### Example 15: Preferred Embodiments

The invention may include one or more of the following preferred embodiments which are set forth in the claims below.

The term “inaudible” does not apply to any specific frequency range but is used as a generic description for an audio or other signal that is generally inaudible, indiscernible, or only slightly discernable by humans and the like. (e.g., frequencies generally above 20 Hz or below 20 kHz). Notably, due to variations in the hearing perceptions among various individual and population distributions, the term “inaudible” may encompass audio signals that are perceptible to humans, as such the term “inaudible” encompasses both slightly audible, subaudible, and inaudible signals.

In one embodiment, an ultrasonic audio signal may be an inaudible signal configured at frequency range at which humans are typically unable to perceive sound (e.g., frequencies generally below 20 Hz or above 20 kHz).

As used herein a “mobile device” is any computer device or system configured to operate the computer executable program of the invention and receive an audio signal. A mobile device may be selected from the group consisting of: a smartphone, a laptop, a computer, a personal digital assistant (PDA), a tablet, a smartwatch, and a mobile communications device.

In one embodiment, used herein a “receiver” may include any hardware or software device or system, or a device or system comprising a combination of hardware and software that is configured to receive and process a signal, such as a wired or wireless digital signal, or preferably an inaudible or ultrasonic signal. In one embodiment a receiver may include a microphone, or other computer-enabled device capable of detecting, processing and/or receiving by direct means an audio signal, and preferably an audible, inaudible, subaudible or ultrasonic signal. In certain preferred embodiment, a receiver may be operably connected to a computer executable program, such as an API of the invention. In another embodiment, a receiver may include a device responsive to a wired or wireless signal, such as an internet or cellular signal that can receive, for example, a packet URL request of the invention. In this embodiment, the present invention allows a third-party content generator to create a unique identifier based on a submitted internet URL, or other digital content to a proprietary secure server. The resultant unique identifier can then be directly transmitted through any digital signal, such as a wired or wireless internet or cellular signal, as well as an audio signal and then received by a receiving device, such as a mobile device that includes a computer executable program configured to receive and identify the unique identifier transmitted by the digital signal. The receiving device is programmed to contact the secure server with a packet URL request. The URL request can be authenticated by comparing the unique identifier provided in the URL request with the unique identifier stored on the secure server that is associated with the target URL. If the unique identifiers match, the URL request is authenticated and the URL, which may be encrypted, is provided to the receiving device, where it may further be decrypted through a digital signal.

A “computer,” “computer system,” “host,” “server,” or “processor” may be, for example and without limitation, a processor, microcomputer, minicomputer, server, mainframe, laptop, personal data assistant (PDA), wireless e-mail device, cellular phone, pager, processor, scanner, or any other programmable device configured to transmit and/or receive data over a network. Computer systems and computer-based devices disclosed herein may include memory for storing certain software modules used in obtaining, processing, and communicating information. It can be appreciated that such memory may be internal or external with respect to operation of the disclosed embodiments. The memory may also include any means for storing software, including a hard disk, an optical disk, floppy disk, ROM (read only memory), RAM (random access memory), PROM (programmable ROM), EEPROM (electrically erasable PROM) and/or other computer-readable media.

As used herein a “URL-associated website” generally refers to one, or a set of related webpages served from a single web domain, and is hosted on at least one web server, accessible via a network such as the Internet or a private local area network through an Internet address, or URL. All publicly accessible websites collectively constitute the World Wide Web. Each webpage is a document, typically written in plain text interspersed with formatting instructions in a language, e.g., Hypertext Markup Language (HTML, XHTML).

As described above, in certain embodiments the computer executable program may direct a mobile device to access a URL, and further may direct the mobile device to display the visual and audio content of said URL-associated website. In this embodiment, the computer executable program, and preferably an API working in conjunction with a software application on said mobile device may cause a separate application, generally referred to as a browser to navigate to a webpage associated with the URL. The browser may display the website, which is rendered according to its HTML markup instructions onto a display terminal, such a screen of a mobile device, where the content and HTML markup instructions have been transported with the Hypertext Transfer Protocol (HTTP).

Any of the computing systems described herein, whether controlled by end users directly or by a remote entity controlling one or more components of said system of the invention, can be implemented as software components executing on one or more general purpose processors or specially designed processors such as programmable logic devices (e.g., Field Programmable Gate Arrays (FPGAs)) and/or Application Specific Integrated Circuits (ASICs) designed to perform certain functions or a combination thereof. In some embodiments, code executed during operation of the systems of the invention (computational elements) can be embodied by a form of software elements which can be stored in a nonvolatile storage medium (such as optical disk, flash storage device, mobile hard disk, cloud-based systems etc.), including a number of instructions for making a computer device (such as personal computers, servers, network equipment, etc.). Algorithms, machine learning models and/or other computational structures described herein may be implemented on a single device or distributed across multiple devices. The functions of the computational elements may be merged into one another or further split into multiple sub-modules.

The hardware device of the invention can be any kind of device that can be programmed including, for example, any kind of computer including smart mobile devices (watches, phones, tablets, and the like), personal computers, powerful servers or supercomputers, or the like. The device includes one or more processors such as an ASIC or any combination processors, for example, one general purpose processor and two FPGAs. The device may be implemented as a combination of hardware and software, such as an ASIC and an FPGA, or at least one microprocessor and at least one memory with software modules located therein. In various embodiments, the system includes at least one hardware component and/or at least one software component. The embodiments described herein could be implemented in pure hardware or partly in hardware and partly in software. In some cases, the disclosed embodiments may be implemented on different hardware devices, for example using a plurality of CPUs equipped with GPUs capable of accelerating and/or coordinating computation. Each computational element may be implemented as an organized collection of computer data and instructions. System software typically interfaces with computer hardware, typically implemented as one or more processors (e.g., CPUs or ASICs as mentioned) and associated memory. In certain embodiments, the system software includes operating system software and/or firmware, as well as any middleware and drivers installed in the system. The system software provides basic non-task-specific functions of the computer. In contrast, the modules and other application software are used to accomplish specific tasks. Each native instruction for a module is stored in a memory device and is represented by a numeric value.

At one level a computational element is implemented as a set of commands prepared by the programmer/developer. However, the module software that can be executed by the computer hardware is executable code committed to memory using “machine codes” selected from the specific machine language instruction set, or “native instructions,” designed into the hardware processor. The machine language instruction set, or native instruction set, is known to, and essentially built into, the hardware processor(s). This is the “language” by which the system and application software communicates with the hardware processors. Each native instruction is a discrete code that is recognized by the processing architecture and that can specify particular registers for arithmetic, addressing, or control functions; particular memory locations or offsets; and particular addressing modes used to interpret operands. More complex operations are built up by combining these simple native instructions, which are executed sequentially, or as otherwise directed by control flow instructions.

The inter-relationship between the executable software instructions and the hardware processor may be structural. In other words, the instructions per se may include a series of symbols or numeric values. They do not intrinsically convey any information. It is the processor, which by design was preconfigured to interpret the symbols/numeric values, which imparts meaning to the instructions.

All of the methods described herein may include storing results of one or more steps of the method embodiments in memory. The results may include any of the results described herein and may be stored in any manner known in the art. The memory may include any memory described herein or any other suitable storage medium known in the art. After the results have been stored, the results can be accessed in the memory and used by any of the method or system embodiments described herein, formatted for display to a user, used by another software module, method, or system, etc. Furthermore, the results may be stored “permanently,” “semi-permanently,” temporarily, or for some period of time. For example, the memory may be random access memory (RAM), and the results may not necessarily persist indefinitely in the memory.

Notably, there are various vehicles by which processes and/or systems and/or other technologies described herein can be affected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be affected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

In some embodiment described herein, logic and similar implementations may include software or other control structures. Electronic circuitry, for example, may have one or more paths of electrical current constructed and arranged to implement various functions as described herein. In some implementations, one or more media may be configured to bear a device-detectable implementation when such media hold or transmit device-detectable instructions operable to perform as described herein, and preferrable transmitted to a mobile device as an audio signal, and even more preferably an inaudible audio signal. In some variants, for example, implementations may include an update or modification of existing software or firmware, or of gate arrays or programmable hardware, such as by performing a reception of or a transmission of one or more instructions in relation to one or more operations described herein. Alternatively, or additionally, in some variants, an implementation may include special-purpose hardware, software, firmware components, and/or general-purpose components executing or otherwise invoking special-purpose components. Specifications or other implementations may be transmitted by one or more instances of tangible transmission media as described herein, optionally by packet transmission or otherwise by passing through distributed media at various times.

Alternatively, or additionally, implementations may include executing a special-purpose instruction sequence or invoking circuitry for enabling, triggering, coordinating, requesting, or otherwise causing one or more occurrences of virtually any functional operations described herein. In some variants, operational or other logical descriptions herein may be expressed as source code and compiled or otherwise invoked as an executable instruction sequence. In some contexts, for example, implementations may be provided, in whole or in part, by source code, such as C++, or other code sequences. In other implementations, source or other code implementation, using commercially available and/or techniques in the art, may be compiled/implemented/translated/converted into a high-level descriptor language (e.g., initially implementing described technologies in C or C++ programming language and thereafter converting the programming language implementation into a logic-synthesizable language implementation, a hardware description language implementation, a hardware design simulation implementation, and/or other such similar mode(s) of expression). For example, some or all of a logical expression (e.g., computer programming language implementation) may be manifested as a Verilog-type hardware description (e.g., via Hardware Description Language (HDL) and/or Very High Speed Integrated Circuit Hardware Descriptor Language (VHDL)) or other circuitry model which may then be used to create a physical implementation having hardware (e.g., an Application Specific Integrated Circuit). Those skilled in the art will recognize how to obtain, configure, and optimize suitable transmission device or computational elements, material supplies, actuators, or other structures in light of these teachings.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link (e.g., transmitter, receiver, transmission logic, reception logic, etc.), etc.).

The various embodiments described herein can be implemented by various types of electro-mechanical systems having a wide range of electrical components such as hardware, software, firmware, and/or virtually any combination thereof; and a wide range of components that may impart mechanical force or motion such as rigid bodies, spring or torsional bodies, hydraulics, electro-magnetically actuated devices, and/or virtually any combination thereof. Consequently, as used herein “electro-mechanical system” includes, but is not limited to, electrical circuitry operably coupled with a transducer (e.g., an actuator, a motor, a piezoelectric crystal, a Micro Electro Mechanical System (MEMS), etc.), electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of memory (e.g., random access, flash, read only, etc.)), electrical circuitry forming a communications device (e.g., a modem, communications switch, optical-electrical equipment, etc.), and/or any non-electrical analog thereto, such as optical or other analogs. Those skilled in the art will also appreciate that examples of electro-mechanical systems include but are not limited to a variety of consumer electronics systems, medical devices, as well as other systems such as motorized transport systems, factory automation systems, security systems, and/or communication/computing systems. Those skilled in the art will recognize that electro-mechanical as used herein is not necessarily limited to a system that has both electrical and mechanical actuation except as context may dictate otherwise.

The various aspects described herein which can be implemented, individually and/or collectively, by a wide range of hardware, software, firmware, and/or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of memory (e.g., random access, flash, read only, etc.)), and/or electrical circuitry forming a communications device (e.g., a modem, communications switch, optical-electrical equipment, etc.). Those having skill in the art will recognize that the subject matter described herein may be implemented in an analog or digital fashion or some combination thereof.

It should be noted that at least a portion of the devices and/or processes described herein can be integrated into a data processing system. Those having skill in the art will recognize that a data processing system generally includes one or more of a system unit housing, a video display device, memory such as volatile or non-volatile memory, processors such as microprocessors or digital signal processors, computational entities such as operating systems, drivers, graphical user interfaces, and applications programs, one or more interaction devices (e.g., a touch pad, a touch screen, an antenna, etc.), and/or control systems including feedback loops and control motors (e.g., feedback for sensing position and/or velocity; control motors for moving and/or adjusting components and/or quantities). A data processing system may be implemented utilizing suitable commercially available components, such as those typically found in data computing/communication and/or network computing/communication systems.

Moreover, the herein described components (e.g., operations), devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken limiting.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “responsive” such that the desired functionality is achieved. Hence, any two components herein combined to achieve a particular functionality can be seen as “responsive with” each other such that the desired functionality is achieved, irrespective of architectures or intermedial components. Likewise, any two components so associated can also be viewed as being “operably connected”, or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components, and/or wirelessly intractable, and/or wirelessly interacting components, and/or logically interacting, and/or logically intractable components.

In some instances, one or more components may be referred to herein as “configured to,” “configurable to,” “responsive to,” “adapted/adaptable,” “able to,” “conformable/conformed to,” etc. Those skilled in the art will recognize that such terms (e.g., “configured to”) can generally encompass active-state components and/or inactive-state components and/or standby-state components, unless context requires otherwise.

While particular aspects of the present subject matter described herein have been shown and described, it will be apparent to those skilled in the art that, based upon the teachings herein, changes and modifications may be made without departing from the subject matter described herein. It will be understood by those within the art that, in general, terms used herein are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B”.

With respect to the appended claims, those skilled in the art will appreciate that recited operations therein may generally be performed in any order. Also, although various operational flows are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

What is claimed is:

1. A method of securely submitting digital content comprising the steps of:
associating a unique identifier with a Uniform Resource Locator (URL) submitted or stored on a secure server;
embedding said unique identifier in an executable audio file and transferring said audio file through a transmission device;
establishing a mobile device having one or more processors responsive to a memory configured to receive said audio signal embedding said unique identifier, and having a computer executable program further configured to transmit a packet URL request to said secure server in response to said audio signal;
authenticating said URL request; and
directing a URL instruction to said mobile device.

2. The method of claim 1, wherein said step of directing a URL instruction comprises the step of directing said mobile device to access said URL and display the visual or audio content of said URL-associated website.

3. The method of claim 1, wherein said computer executable program comprises an Application Programming Interface (API).

4. The method of claim 1, wherein said audio signal embedding said unique identifier comprises an encrypted packet comprising an audio file embedding said unique identifier.

5. The method of claim 4, wherein said encrypted packet comprising an audio file embedding said unique identifier comprises a Waveform Audio (WAV) or other encoded audio format file embedding said unique identifier.

6. The method of claim 1, wherein said mobile device comprises a mobile device selected from the group consisting of: a smartphone, a laptop, a computer, a personal digital assistant (PDA), a tablet, a smartwatch, and a mobile communications device.

7. The method of claim 1, wherein said audio signal embedding said unique identifier is selected from the group consisting of: an audible audio signal, an inaudible audio signal, a subaudible audio signal, and an ultrasonic audio signal, or a combination of the same.

8. The method of claim 1, further comprising programming said audio signal to fall within the available bandwidth parameters of the expected transmission pathway.

9. The method of claim 8, wherein said transmission pathway is selected from the group consisting of: a radio broadcast, an over-the-air video broadcast, an over the air audio broadcast, a cable broadcast transmission, a video broadcast transmission, an audio broadcast transmission, a video streaming transmission, an audio streaming transmission.

10. The method of claim 1, wherein said step of receiving comprises the step of directly receiving said audio signal from said mobile device.

11. The method of claim 1, wherein said step of receiving comprises the step of receiving said audio signal through a receiver on said mobile device and wherein said receiver on said mobile device further comprises a microphone.

12. The method of claim 1, wherein said step of transmitting comprises the step of transmitting said audio signal through a transmission device.

13. The method of claim 12, wherein said transmission device is separate from said mobile device.

14. The method of claim 13, wherein said step of transmission device is selected from the group consisting of: a speaker system, an array of speakers, a digital speaker, and amplifier, a loudspeaker, a speaker responsive to a digital device, a speaker responsive to a computer, and a speaker responsive to a mobile device.

15. A method of securely submitting digital content comprising the steps of:
establishing digital content to be securely delivered to a mobile device;
transmitting and saving said digital content to a secure server;
associating a unique identifier with said digital content;
generating a encrypted packet embedding said unique identifier;
transmitting said encrypted packet through an audio signal;
establishing a mobile device having one or more processors responsive to a memory, and configured to receive said audio signal;
activating a computer executable program in response to said received audio signal that identifies said encrypted packet and initiates a digital content request directed to said secure server;
authenticating said digital content request by comparing it with said unique identifier associated with said digital content;
transmitting said digital content or a digital content instruction to said mobile device; and
accessing said digital content on said mobile device.

16. The method of claim 15, further comprising encrypting said digital content transmitted and saved to said secure server.

17. The method of claim 15, further comprising decrypting said digital content.

18. The method of claim 15, wherein said step of establishing digital content comprises the step of establishing a Uniform Resource Locator (URL).

19. The method of claim 15, wherein the step of accessing said digital content comprises the step of directing said mobile device to access said URL and display the visual or audio content of said URL-associated website.

20. The method of claim 15, wherein said computer executable program comprises an Application Programming Interface (API).

21. The method of claim 15, wherein said encrypted packet comprises an audio file embedding said unique identifier.

22. The method of claim 21, wherein said audio file embedding said unique identifier comprises a Waveform Audio (WAV) or other encoded audio format file embedding said unique identifier.

23. The method of claim 15, wherein said mobile device comprises a mobile device selected from the group consisting of: a smartphone, a laptop, a computer, a personal digital assistant (PDA), a tablet, a smartwatch, and a mobile communications device.

24. The method of claim 15, wherein said audio signal is selected from the group consisting of: an audible audio signal, an inaudible audio signal, a subaudible audio signal, and an ultrasonic audio signal, or a combination of the same.

25. The method of claim 24, further comprising programming said audio signal to fall within the available bandwidth parameters of the expected transmission pathway.

26. The method of claim 25, wherein said transmission pathway is selected from the group consisting of: a radio broadcast, an over-the-air video broadcast, an over the air audio broadcast, a cable broadcast transmission, a video broadcast transmission, an audio broadcast transmission, a video streaming transmission, an audio streaming transmission.

27. The method of claim 15, wherein said step of receiving comprises the step of receiving said audio signal through a receiver responsive to said mobile device.

28. The method of claim 27, wherein said receiver comprises a microphone.

29. The method of claim 15, wherein said step of transmitting said digital content comprises the step of transmitting said audio signal through a transmission device.

30. The method of claim 29, wherein said transmission device is separate from said mobile device.

31. The method of claim 30, wherein said transmission device is selected from the group consisting of: a speaker system, an array of speakers, a digital speaker, and amplifier, a loudspeaker, a speaker responsive to a digital device, a speaker responsive to a computer, and a speaker responsive to a mobile device.

32. The method of claim 15, wherein said step of establishing digital content comprises the step of generating automated URLs to be securely delivered to said mobile device.

33. The method of claim 32, wherein said step of generating automated digital URLs to be securely delivered to said mobile device comprises the step of generating automated digital content from pre-generated URLs.

34. A method of securely transmitting a Uniform Resource Locator (URL) comprising the steps of:
generating a target URL to be securely transmitted to a mobile device;
transmitting said target URL to a secure packet server to be encrypted and stored;
associating said target URL with a unique identifier;
creating an encrypted packet containing said unique identifier embedded in an executable audio file;
integrating said encrypted packet into an audible audio signal;
transmitting said audible audio signal having said integrated encrypted packet through a transmission device wherein said audible audio signal is received by a mobile device, wherein said step of receiving activates a computer executable program that initiates the following steps:
recognizing said encrypted packet;
sending a packet URL request to said secure server;
authenticating said packet URL request by comparing said encrypted packet with said unique identifier associated with said target URL;
transmitting a target URL instruction associated with said encrypted packet to said mobile device when said encrypted packet and said unique identifier are matched;
directing said mobile device to access said URL.

35. The method of claim 34, wherein said mobile device comprises a mobile device selected from the group consisting of: a smartphone, a laptop, a computer, a personal digital assistant (PDA), a tablet, a smartwatch, and a mobile communications device.

36. The method of claim 34, further comprising the step of directing said packet URL request to a third party server which is responsive to a secure server.

37. The method of claim 34, wherein said step of generating a target URL comprises the steps of:
establishing a client computer responsive to said secure server;
accessing said client computer; and
inputting one or more target URLs to be transmitted to said secure server.

38. The method of claim 37, wherein said step of inputting one or more target URLs comprises the step of inputting a plurality of target URL's to be transmitted to a secure server in series, in parallel, at a pre-determined time or event, or in response to an automated or manual signal.

39. The method of claim 37, wherein said step of inputting one or more target URLs comprises the step of automatically populating a plurality of target URLs from a pool of pre-populated target URLs.

40. The method of claim 34, wherein said computer executable program comprises an Application Programming Interface (API).

41. The method of claim 40, wherein said API is responsive to a computer executable application operation said mobile device.

42. The method of claim 34, wherein said audio signal is selected from the group consisting of: an audible audio signal, an inaudible audio signal, a subaudible audio signal, and an ultrasonic audio signal, or a combination of the same.

43. The method of any of claim 34 or 42, wherein said encrypted packet containing said unique identifier embedded in an executable audio file comprises an audio file selected from the group consisting of: an audible audio signal, an inaudible audio signal, a subaudible audio signal, and an ultrasonic audio signal, or a combination of the same.

44. The method any of claims 34-43, wherein said step of transmitting said audio signal comprises the step of a transmitting an inaudible audio signal, with a second audible audio file, or integrated with a second audible audio file.

45. The method of any of claims 34-43, wherein said step of transmitting said audio signal comprises the step of a transmitting a Waveform Audio (WAV) or other encoded audio format file embedding said unique identifier.

46. The method of any of claims 34-43, wherein said audio signal comprises an inaudible WAV or other encoded audio format audio signal embedding said unique identifier.

47. The method of claim 34, wherein said step of transmitting said target URL to a secure packet server comprises the step of transmitting said target URL to a secure packet server through a network, wherein said network is selected from the group consisting of: an internet network, a wireless network, a Local Area Network (LAN) connection, a Wide Area Network (WAN), Metropolitan Area Network (MAN).

48. The method of claim 34, wherein said transmission device is separate from said mobile device.

49. The method of claim 48, wherein said transmission device is selected from the group consisting of: a speaker system, an array of speakers, a digital speaker, and amplifier, a loudspeaker, a speaker responsive to a digital device, a speaker responsive to a computer, and a speaker responsive to a mobile device.

50. The method of claim 34, wherein said step of receiving said audio signal comprises the step of receiving said audio signal through a receiver responsive to said mobile device.

51. The method of any of claims 40 and 50, wherein said receiver comprise a microphone responsive to said API.

52. The method of claim 34, wherein said step of sending a packet URL request comprises the step of sending a packet URL request through a wired, or wireless network.

53. The method of claim 34, wherein said unique identifier comprises a randomly generated numerical identifier.

54. The method of claim 34, wherein said step of directing said mobile device to access said URL comprises the step of directing said mobile device to access said URL through a browser application.

55. The method of claim 34, wherein said step of transmitting said target URL to a secure packet server to be encrypted and stored comprises the step of transmitting said target URL to a secure packet server to be encrypted and stored through a management server.

56. The method of claim 55, wherein said management server is separate from said secure packet server.

57. The method of claim 34, further comprising the step of communicating with a Data Logging server.

58. The method of claim 34, wherein said step of generating a target URL to be securely transmitted to a mobile device comprises the step of generating a target URL to be securely transmitted to a mobile device by a third party.

59. The method of claim 58, wherein said third party comprises computer executable application operation on said mobile device operated by said same third party that generated the target URL.

60. The method of any of claims 34-59, wherein said step of authenticating said packet URL request further comprises comparing said encrypted packet with said third party that generated and encrypted said target URL.

61. The method of any of claim 34, further comprising programming said audio signal to fall within the available bandwidth parameters of the expected transmission pathway

62. The method of claim 61, wherein said transmission pathway is selected from the group consisting of: a radio broadcast, an over-the-air video broadcast, an over the air audio broadcast, a cable broadcast transmission, a video broadcast transmission, an audio broadcast transmission, a video streaming transmission, an audio streaming transmission.

63. A system of securely transmitting a Uniform Resource Locator (URL) comprising:
a client computer, having one or more processors responsive to a memory, and configured to input a Uniform Resource Locator (URL) to be transmitted to a mobile device;
a secure packet server configured to associate said URL with a unique identifier and generate an encrypted packet containing said unique identifier embedded in an executable audio file;
a transmission device configured to receive and transmit the audio signal of said executable audio file;
a mobile device, having one or more processors responsive to a memory, and configured to receive said audio signal and activate a computer executable program that sends a packet URL request to said secure packet server; and
wherein said packet URL request is authenticated by said secure packet server comparing said encrypted packet containing said unique identifier associated with said URL, and further wherein said secure packet server transmits a URL instruction to said mobile device when said URL request is authenticated.

64. The system of claim 63, wherein said mobile device comprises a mobile device selected from the group consisting of: a smartphone, a laptop, a computer, a personal digital assistant (PDA), a tablet, a smartwatch, and a mobile communications device.

65. The system of claim 63, wherein said URL to be transmitted comprises a plurality of target URL's to be transmitted to a secure packet server in series, in parallel, at a pre-determined time or event, or in response to an automated or manual signal.

66. The system of claim 63, wherein said URL to be transmitted comprises a plurality of pre-populated URLs.

67. The system of claim 63, wherein said computer executable program comprises an Application Programming Interface (API).

68. The system of claim 67, wherein said API is responsive to a computer executable application operation on said mobile device.

69. The system of claim 63, wherein said audio signal comprises an audio signal selected from the group consisting of: comprises an audible audio signal, an inaudible audio signal, an subaudible audio signal, and an ultrasonic audio signal, or a combination of the same.

70. The system of claim 63, wherein said audio signal is programed to fall within the available bandwidth parameters of the expected transmission pathway

71. The system of claim 70, wherein said transmission pathway is selected from the group consisting of: a radio broadcast, an over-the-air video broadcast, an over the air audio broadcast, a cable broadcast transmission, a video broadcast transmission, an audio broadcast transmission, a video streaming transmission, an audio streaming transmission.

72. The system of any of claim 63, wherein said encrypted packet containing said unique identifier embedded in an executable audio file comprises an inaudible audio file.

73. The system any of claims 63-70, wherein said executable audio file comprises and inaudible executable audio file embedded in a second audible audio file.

74. The system of any of claim 72 or 73, wherein said inaudible audio file comprises an ultrasonic or subaudible executable audio file.

75. The system of any of claim 63 or 72-74, wherein said audio file comprises a Waveform Audio (WAV) or other encoded audio format file embedding said unique identifier.

76. The system of claim 63, further comprising a network configured to transmitting said target URL to a secure packet server and an executable audio file to said mobile phone wherein said network is selected from the group consisting of: an internet network, a wireless network, a Local Area Network (LAN) connection, a Wide Area Network (WAN), Metropolitan Area Network (MAN).

77. The system of claim 63, wherein said transmission device is separate from said mobile device.

78. The system of claim 77, wherein said transmission device is selected from the group consisting of: a speaker system, an array of speakers, a digital speaker, and amplifier, a loudspeaker, a speaker responsive to a digital device, a speaker responsive to a computer, and a speaker responsive to a mobile device.

79. The system of claim 63, wherein said mobile device includes a receiver configured to receive said audio signal.

80. The system of claim 79, wherein said receiver comprises a microphone responsive to said API.

81. The system of claim 63, wherein said unique identifier comprises a randomly generated numerical identifier.

82. The system of claim 63, further comprising a management server configured to transmit said URL to a secure packet server to be encrypted.

83. The system of claim 82, wherein said management server is separate from said secure packet server.

84. The system of claim 63, further comprising a data logging server responsive to said management server and said management server.

85. A method of securely submitting digital content comprising the steps of:
associating a unique identifier with a Uniform Resource Locator (URL) submitted or stored on a secure server;
embedding said unique identifier in an executable audio file and transferring said audio file through a transmission device, wherein the parameters of the audio signal of said audio file are adapted to fall within the available bandwidth parameters of the expected transmission pathway;
establishing a mobile device having one or more processors responsive to a memory configured to receive said audio signal embedding said unique identifier, and having a computer executable program further configured to transmit a packet URL request to said secure server in response to said audio signal;
authenticating said packet URL request; and
directing a URL instruction to said mobile device.

86. The method of claim 85, further comprising the step of directing said mobile device to access said URL and display the visual or audio content of said URL-associated website.

87. The method of claim 85, wherein said computer executable program comprises an Application Programming Interface (API).

88. The method of claim 85, wherein said audio signal embedding said unique identifier comprises an encrypted packet comprising an audio file embedding said unique identifier.

89. The method of claim 88, wherein said encrypted packet comprising an audio file embedding said unique identifier comprises a Waveform Audio (WAV) or other encoded audio format file embedding said unique identifier.

90. The method of claim 85, wherein said mobile device comprises a mobile device selected from the group consisting of: a smartphone, a laptop, a computer, a personal digital assistant (PDA), a tablet, a smartwatch, and a mobile communications device.

91. The method of claim 85, wherein said audio signal embedding said unique identifier is selected from the group consisting of: an audible audio signal, an inaudible audio signal, a subaudible audio signal, and an ultrasonic audio signal, or a combination of the same.

92. The method of claim 85, wherein said transmission pathway is selected from the group consisting of: a radio broadcast, an over-the-air video broadcast, an over the air audio broadcast, a cable broadcast transmission, a video broadcast transmission, an audio broadcast transmission, a video streaming transmission, an audio streaming transmission.

93. The method of claim 85, wherein said step of receiving comprises the step of directly receiving said audio signal from said mobile device.

94. The method of claim 85, wherein said step of receiving comprises the step of receiving said audio signal through a receiver on said mobile device and wherein said receiver on said mobile device further comprises a microphone.

95. The method of claim 85, wherein said step of transmitting comprises the step of transmitting said audio signal through a transmission device.

96. The method of claim 95, wherein said transmission device is separate from said mobile device.

97. The method of claim 96, wherein said step of transmission device is selected from the group consisting of: a speaker system, an array of speakers, a digital speaker, and amplifier, a loudspeaker, a speaker responsive to a digital device, a speaker responsive to a computer, and a speaker responsive to a mobile device.

98. A method of securely submitting digital content comprising the steps of:
establishing digital content to be securely delivered to a mobile device;
transmitting and saving said digital content to a secure server;
associating a unique identifier with said digital content;
generating a encrypted packet embedding said unique identifier;
transmitting said encrypted packet through an audio signal, wherein the parameters of the audio signal are adapted to fall within the available bandwidth parameters of the expected transmission pathway;
establishing a mobile device having one or more processors responsive to a memory, and configured to receive said audio signal;
activating a computer executable program in response to said received audio signal that identifies said encrypted packet and initiates a digital content request directed to said secure server;
authenticating said digital content request by comparing it with said unique identifier associated with said digital content;
transmitting said digital content or a digital content instruction to said mobile device; and
accessing said digital content on said mobile device.

99. The method of claim 98, further comprising encrypting said digital content transmitted and saved to said secure server.

100. The method of claim 98, further comprising decrypting said digital content.

101. The method of claim 98, wherein said step of establishing digital content comprises the step of establishing a Uniform Resource Locator (URL).

102. The method of claim 98, wherein the step of accessing said digital content comprises the step of directing said mobile device to access said URL and display the visual or audio content of said URL-associated website.

103. The method of claim 98, wherein said computer executable program comprises an Application Programming Interface (API).

104. The method of claim 98, wherein said encrypted packet comprises an audio file embedding said unique identifier.

105. The method of claim 98, wherein said audio file embedding said unique identifier comprises a Waveform Audio (WAV) or other encoded audio format file embedding said unique identifier.

106. The method of claim 98, wherein said mobile device comprises a mobile device selected from the group consisting of: a smartphone, a laptop, a computer, a personal digital assistant (PDA), a tablet, a smartwatch, and a mobile communications device.

107. The method of claim 98, wherein said audio signal is selected from the group consisting of: an audible audio signal, an inaudible audio signal, a subaudible audio signal, and an ultrasonic audio signal, or a combination of the same.

108. The method of claim 98, wherein said transmission pathway is selected from the group consisting of: a radio broadcast, an over-the-air video broadcast, an over the air audio broadcast, a cable broadcast transmission, a video broadcast transmission, an audio broadcast transmission, a video streaming transmission, an audio streaming transmission.

109. The method of claim 98, wherein said step of receiving comprises the step of receiving said audio signal through a receiver responsive to said mobile device.

110. The method of claim 109, wherein said receiver comprises a microphone.

111. The method of claim 98, wherein said step of transmitting said digital content comprises the step of transmitting said audio signal through a transmission device.

112. The method of claim 111, wherein said transmission device is separate from said mobile device.

113. The method of claim 112, wherein said transmission device is selected from the group consisting of: a speaker system, an array of speakers, a digital speaker, and amplifier, a loudspeaker, a speaker responsive to a digital device, a speaker responsive to a computer, and a speaker responsive to a mobile device.

114. The method of claim 98, wherein said step of establishing digital content comprises the step of generating automated URLs to be securely delivered to said mobile device.

115. The method of claim 114, wherein said step of generating automated digital URLs to be securely delivered to said mobile device comprises the step of generating automated digital content from pre-generated URLs.

116. The method or system of any claim above, wherein said inaudible audio signal is masked by a synchronized audible audio signal.

116. The method of any claim above, and further comprising determining the available bandwidth of digital audio transmission to allocate the appropriate encryption packet frequencies for the said encoded packet.

117. The system of any claim above, and further comprising wherein the available bandwidth of digital audio transmission is determined to allocate the appropriate encryption packet frequencies for the said encoded packet.

1-117. (canceled)

118. A method of transmitting digital content via an audio signal comprising the steps of:
establishing digital content associated with a Uniform Resource Identifier (URI) configured to be displayed or acted upon by a receiving device;
associating a unique identifier code with the URI;
creating an inaudible audio signal encoding said unique identifier code as a sound;
embedding the inaudible audio signal into an audible audio signal forming a combined audio signal;
broadcasting the combined audio signal to the receiving device that identifies the inaudible audio signal and extracts the unique identifier code; and
transmitting the unique identifier code to a secure server for authentication, whereupon the URI associated with the digital content is directed to the receiving device where it is displayed or acted upon by the receiving device.

119. The method of claim 118, wherein said receiving device comprises a computing device having one or more processors responsive to a memory and configured to receive the combined audio signal and identify the unique identifier code from the inaudible audio signal encoding said unique identifier code as a sound.

120. The method of claim 119, wherein the receiving device includes microphone for receiving the combined audio signal.

121. The method of claim 120, wherein said receiving device is selected from: a smartphone, a laptop, a computer, a personal digital assistant (PDA), a tablet, a smartwatch, or a mobile communications device.

122. The method of claim 118, wherein said receiving device comprises a computer executable program configured to transmit a packet URI request to said secure server in response to said inaudible audio signal.

123. The method of claim 122, wherein said wherein said computer executable program comprises an Application Programming Interface (API).

124. The method of claim 118, wherein said combined audio signal is broadcast through a transmission device selected from: a speaker system, an array of speakers, a digital speaker, and amplifier, a loudspeaker, a speaker responsive to a digital device, a speaker responsive to a computer, and a speaker responsive to a mobile device.

125. The method of claim 124, wherein the broadcast transmission device is separate from said receiving device.

126. The method of claim 118, wherein said broadcast is selected from: a radio broadcast, an over-the-air video broadcast, an over the air audio broadcast, a cable broadcast transmission, a video broadcast transmission, an audio broadcast transmission, a video streaming transmission, an audio streaming transmission.

127. The method of claim 118, wherein the inaudible audio signal falls within the available bandwidth parameters of the broadcast transmission.

128. The method of claim 118, wherein said inaudible audio signal comprises a subaudible audio signal, an ultrasonic audio signal, or a combination of the same.

129. The method of claim 118, wherein said digital content comprises visual or audio content configured to be displayed or acted on by the receiving device.

130. The method of claim 118, wherein said step of transmitting comprises transmitting the unique identifier code to the secure server for authentication, wherein the transmission is encrypted.

131. The method of claim 118, wherein the transmission from the server to the receiving device is encrypted.

132. The method of claim 118, wherein said URI comprises a Uniform Resource Locator (URL), a Uniform Resource Number (URN), a domain name, an Internet Protocol (IP) address, a computer executable program, or a combination of the same.

133. The method of claim 118, wherein said step of establishing digital content associated with a URI comprises the steps of:
establishing a client computer responsive to said secure server; and
inputting one or more target URIs to be transmitted to said secure server.

134. The method of claim 133, wherein said step of inputting one or more target URIs comprises the step of inputting a plurality of target URIs to be transmitted to a secure server in series, in parallel, at a pre-determined time or event, or in response to an automated or manual signal.

135. The method of claim 133, wherein said step of inputting one or more target URIs comprises the step of automatically populating a plurality of target URIs from a pool of pre-populated target URIs.

136. The method of claim 118, wherein said unique identifier code comprises a numerical code, or an alpha-numerical code.

137. A method of transmitting digital content via inaudible audio signals comprising the steps of:
establishing digital content associated with a Uniform Resource Identifier (URI);
associating a unique identifier code with the URI;
creating an inaudible audio signal which encodes said unique identifier code as a sound;
broadcasting the inaudible audio signal to a receiving device that identifies the inaudible audio signal and extracts the unique identifier code;
transmitting the unique identifier code to a secure server for authentication, whereupon the URI associated with the digital content is directed to the receiving device where it is displayed or acted upon by the receiving device.
